(19) United States
(12) Patent Application Publication
(10) Pub. No.: US 2016/0293324 A1
(43) Pub. Date: Oct. 6, 2016

(54) BOBBIN STRUCTURE OF TRANSFOMER

(71) Applicant: Chicony Power Technology Co., Ltd., New Taipei City (TW)

(72) Inventors: Yung-Hung HSIAO, New Taipei City (TW); Hao-Te HSU, New Taipei City (TW); Shih-Hung LO, New Taipei City (TW)

(21) Appl. No.: 14/677,264

(22) Filed: Apr. 2, 2015

(51) Int. Cl. H01F 27/32; H01F 27/28; H01F 27/29

(52) U.S. Cl. CPC H01F 27/325; H01F 27/29; H01F 27/2823; H01F 2027/297

(57) ABSTRACT

A bobbin structure of a transformer includes a winding frame. The winding frame includes a first winding section, two second winding sections formed on two sides of the first winding section and a channel penetrating the first winding section and the second winding sections. At least one slot is disposed on each second winding section. Thereby, the assembly process of the bobbin structure of the transformer is simplified and the assembly time is reduced.

### TECHNICAL FIELD

The disclosure relates to a bobbin, more particularly to a bobbin structure of a transformer.

### BACKGROUND

Transformers are electronic components widely used in electronic products. It transfers a current into another proportion of current for other electronic components to use.

Traditionally, a transformer comprises a winding frame, a magnetic core set, a primary winding and a secondary winding, in which the primary winding and the secondary winding are wound around each winding section of the winding frame, separately. A part of the magnetic core set goes through the winding section of the winding frame. This way, a current goes through the primary winding to make the magnetic core set induce a magnetic field, thereby generating an induced current at the secondary winding.

As electronic technology develops, the efficiency of power conversion regarding the electronic products becomes more essential. The safety standard of the products also becomes stricter, especially for the safety standard for the usage of the primary winding and the secondary winding of a transformer. Since today's transformer utilizes the thin copper wire for coils, it is difficult to be wound and makes assembly complicated and slow. Additionally, it can only sustain a small amount of current due to the thin copper wire and has safety issues during the operation. Hence, it is crucial to design an improved transformer capable of solving these problems.

### SUMMARY

One goal of the disclosure is to provide a bobbin structure of a transformer with a simplified assembly process which reduces its assembly time.

To reach this goal, the disclosure provides a bobbin structure of a transformer comprising a winding frame. The winding frame comprises a first winding section, two second winding sections formed on two sides of the first winding section and a channel penetrating the first winding section and the second winding sections. At least one slot is disposed on each second winding section.

Moreover, the disclosure may also achieve other effects. Since the conducting ring performs as a secondary winding, it can sustain greater current output. Each conducting plate is connected to the winding frame by plugging so the maintenance only requires replacing damaged components, which is more economical. By forming the air hole on the first winding section, gas with lower temperature from outside area may enter into the inside of the winding frame to perform heat exchange and may take away the heat generated from the operation of each winding.

### BRIEF DESCRIPTION OF THE DRAWINGS

The disclosure will become more fully understood from the detailed description and the drawings given herein below for illustration only, and thus does not limit the disclosure, wherein:

FIG. 1 is an exploded view of a bobbin according to the disclosure;

FIG. 2 is a perspective view of the bobbin according to the disclosure;

FIG. 3 shows FIG. 2 from another angle;

FIG. 4 is a sectional view of FIG. 2 along the sectional line 4-4;

FIG. 5 is a sectional view of FIG. 2 along the sectional line 5-5;

FIG. 6 is a sectional view of FIG. 2 along the sectional line 6-6; and

FIG. 7 is a sectional view of another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

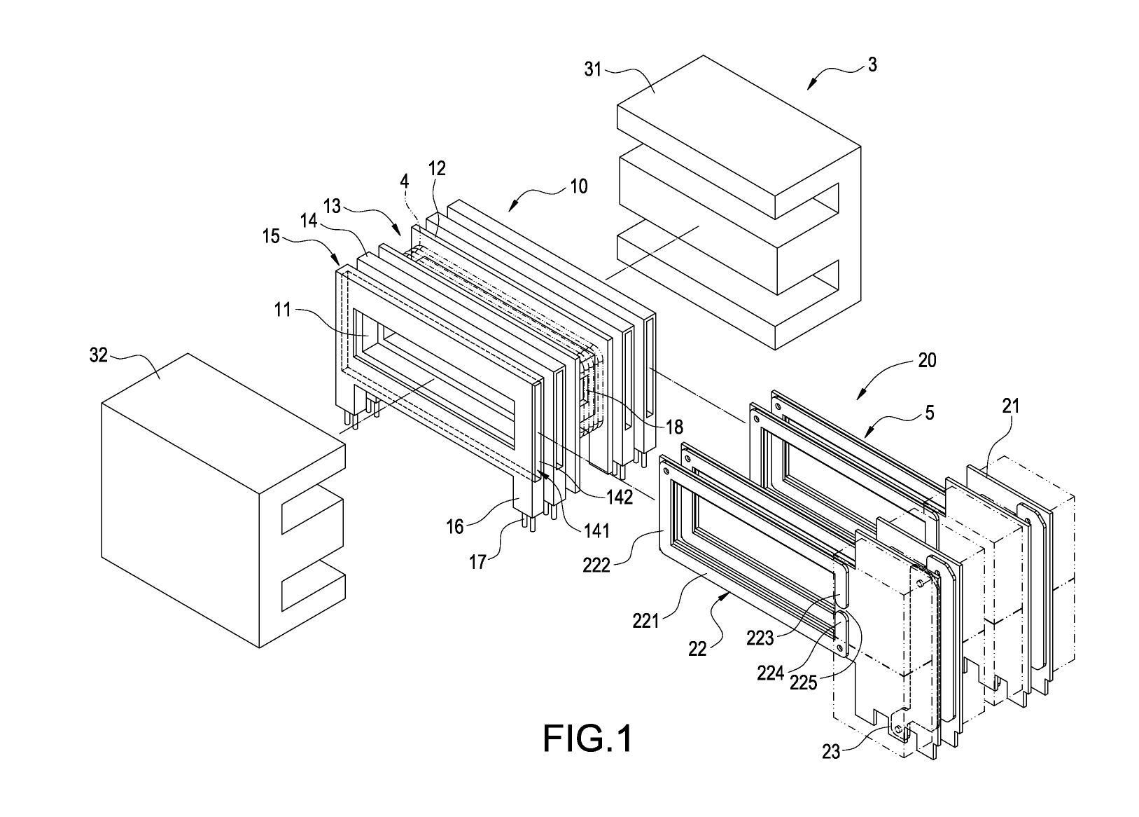

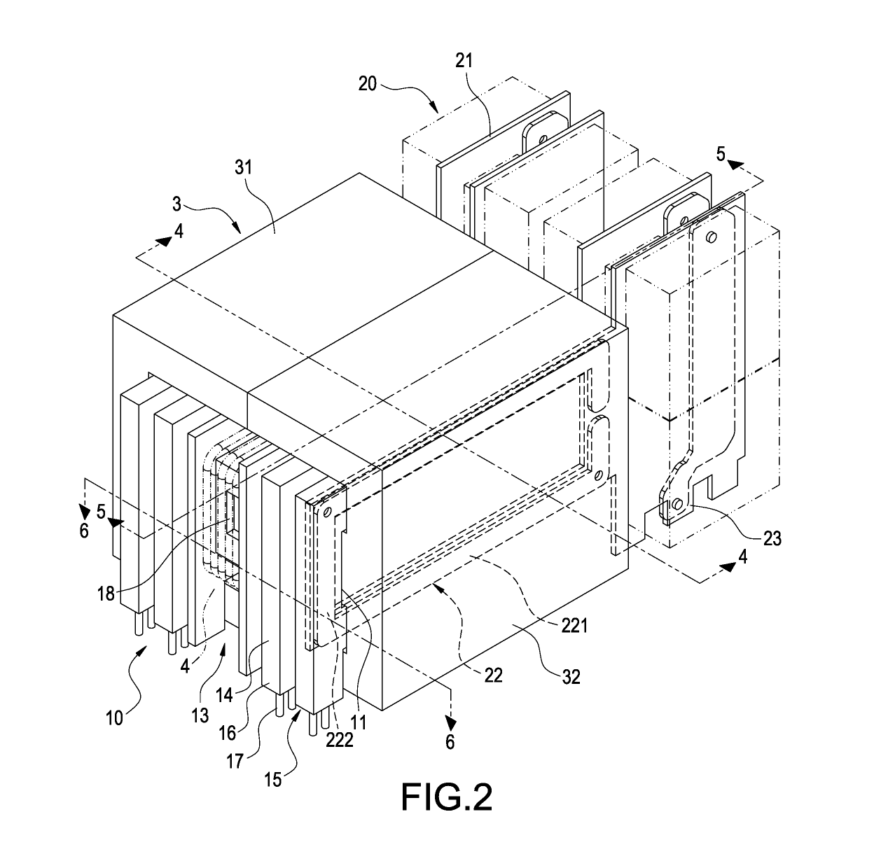

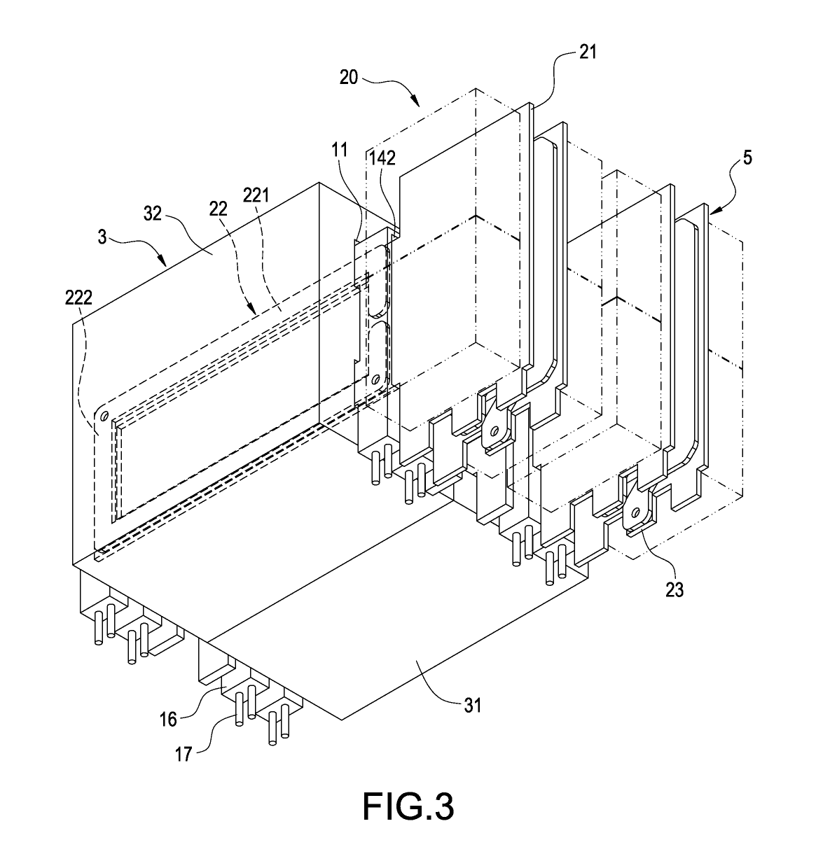

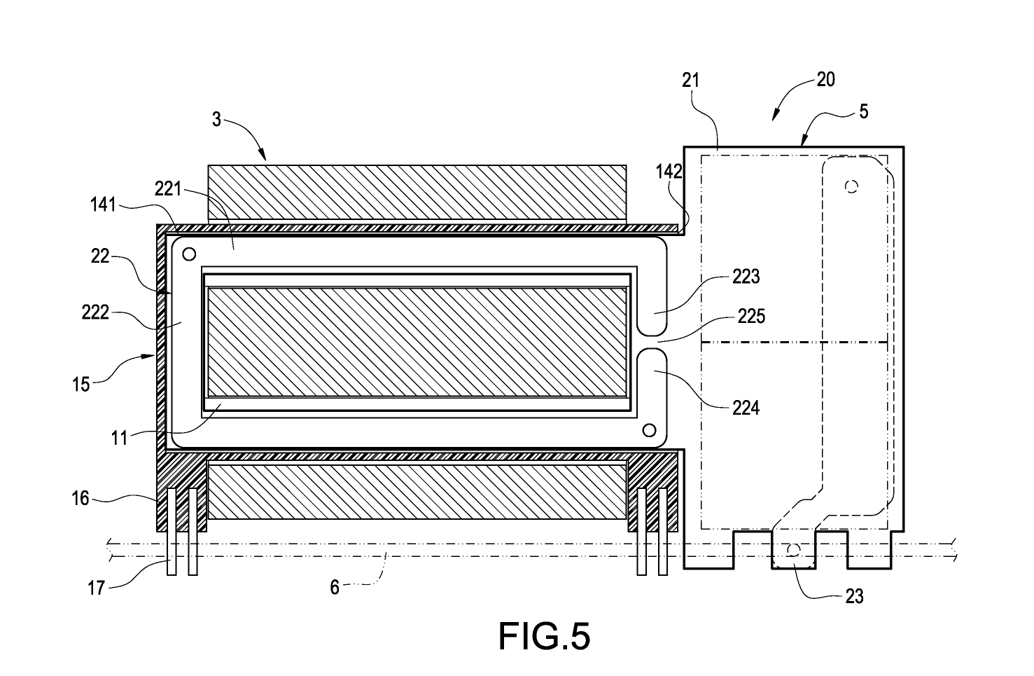

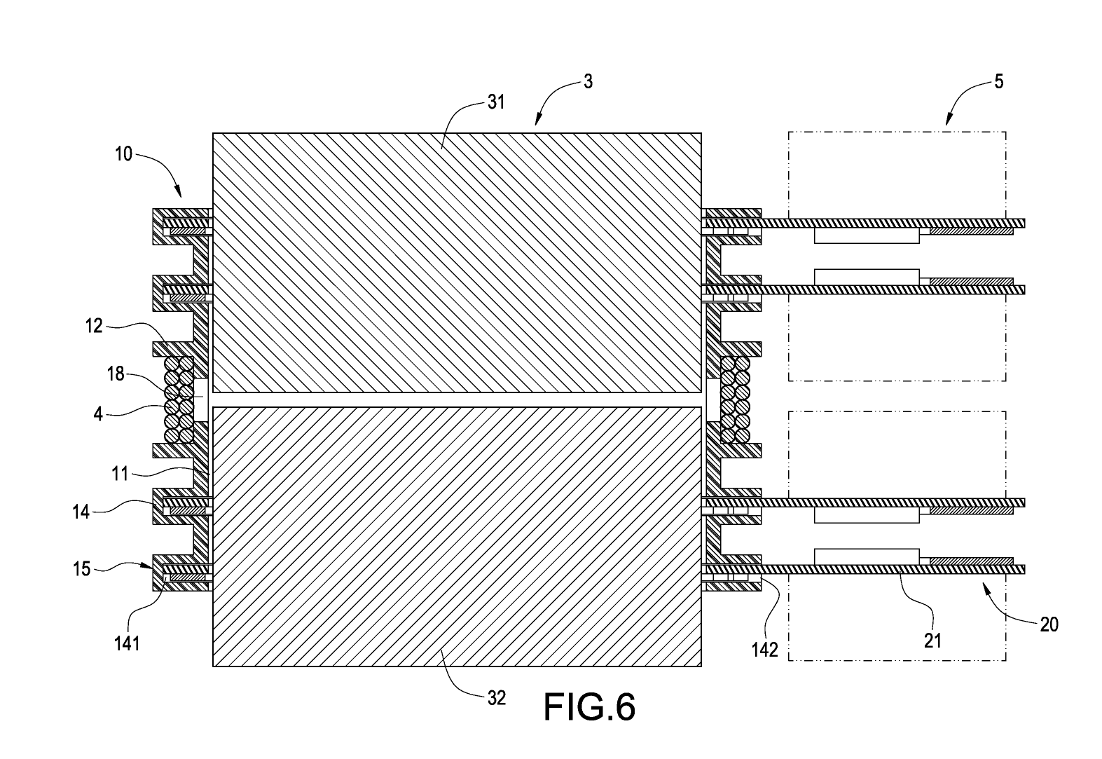

Referring to FIG. 1 to FIG. 6, the disclosure provides a bobbin structure of a transformer mainly comprising a winding frame 10 made of plastic insulation materials. The winding frame 10 is a hollow rectangular body and has a rectangular channel 11 parallel to the centerline. Further, two vertical plates 12 parallel to and spaced apart from each other are disposed and extends towards a direction perpendicular to the centerline. A first winding section 13 is formed between the two vertical plates 12 in order for a primary winding 4 to be wound around.

An outer area of each vertical plate 12 extends and forms a plurality of separation plates 14. Each separation plate 14 is roughly parallel to each vertical plate 11. A slot 141 connecting with the channel 11 is disposed on each separation plate 14 and each slot 141 has a plugging hole 142 formed on a lateral side of the separation plate 14. An area formed by each separation plate 14 becomes a second winding section 15.

Two sides of the bottom of each separation plate 14 extend and form two pin plates 16. The bottom of each pin plate 16 is connected with two pins 17 for an outlet side of the primary winding 4 to be electrically connected to. Besides, an air hole 18 connecting with the rectangular channel 11 is formed in the first winding section 13.

The bobbin structure of the disclosure further comprises a plurality of conducting plates 20. Each conducting plate 20 has a main body 21 and a conducting ring 22 fixed to the main body 21. In this embodiment, the main body 21 is a circuit board and is in a reversed-T shape. The conducting ring 22 may be a copper sheet or a copper foil and is plugged into the plugging hole 142 of the slot 141 in order to be connected to the winding frame 10, thereby becoming a secondary winding 5. Since the cross-sectional area of the conducting ring 22 is greater than that of the traditional winding, the conducting ring 22 as a secondary winding can sustain a greater current, compared to a normal coil as a secondary winding in the traditional transformer.

Moreover, the conducting ring 22 of this embodiment comprises two horizontal sections 221 parallel to each other, a first vertical section 222 bending and extending from one end of each horizontal section 221 and perpendicular to the horizontal section 222 and a third vertical section 223 as well as a fourth vertical section 224 bending and extending from the other end of each horizontal section 221 towards the opposite direction and perpendicular to the horizontal section 221. The third vertical section 223 and the fourth vertical section 224 are parallel to the first vertical section 221. An opening 225 is formed between the third vertical section 223 and the fourth vertical section 224. This conducting ring 22 is attached to and fixed to one side of the main body 21 while the opening 225 thereof is located on a wide end near the main body 21. The wide end of each main body 21 extends downwardly and forms two pins 23 for the outlet side of the secondary winding 5 to be electrically connected to.

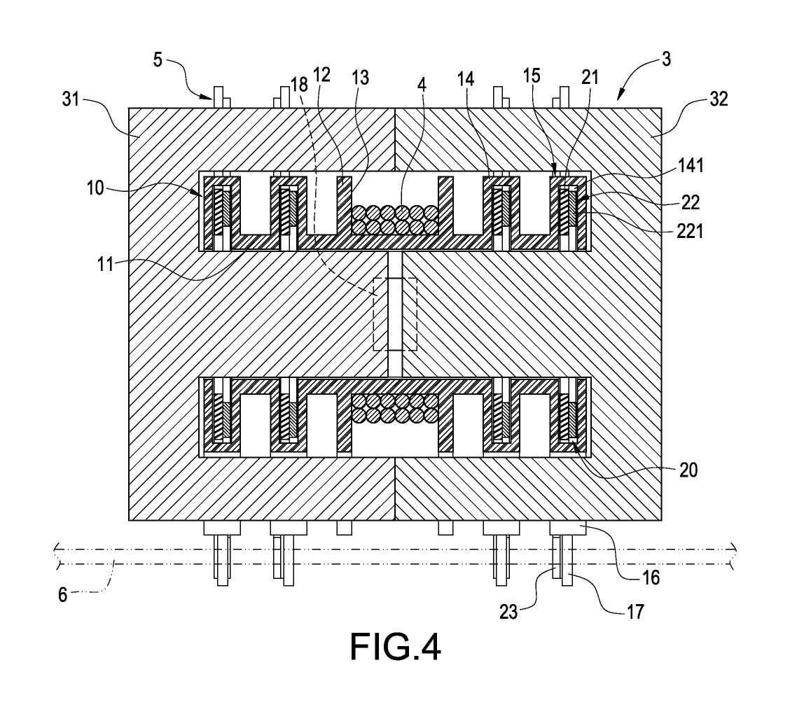

The bobbin structure of the disclosure may be assembled to a magnetic core set 3 for forming a transformer. The magnetic core set 3 comprises a first magnetic core 31 and a second magnetic core 2. Both the first magnetic core 31 and the second magnetic core 2 are in a shape similar to English letter E. A central protruding part of each magnetic core (31, 32) goes through the inside of the channel 11 and forms a spacing gap corresponding to the arrangement of the air hole 18. An upper protruding part and the lower protruding part of each magnetic core (31, 32) respectively cover the top surface and the bottom surface of each separation plate 14 and the primary winding 4. Additionally, the upper protruding part and the lower protruding part are connected together (as shown in FIG. 4) to form a transformer.

This transformer may be installed on a circuit board 6 via holes or grooves on the circuit board (not shown in the figures) designed for each pin (17, 23) to be plugged into. When a current goes through the primary winding 4 and the secondary winding 5, heat will be generated thereon. Meanwhile, the air hole 18 and the spacing gap together form a heat dissipation channel to dissipate heat to the outside area. Furthermore, the top of the primary winding 4 and the bottom of the upper and lower protruding part of each magnetic core (31, 32) also form a heat dissipation channel. On the other hand, any two adjacent separation plates 14 or the separation plate 14 and the vertical plate 12 form a heat dissipation channel therebetween (as seen in FIG. 4). This way, gas with low temperature from outside area is able to enter into the inside of the transformer and thus takes away the heat generated by each heating element.

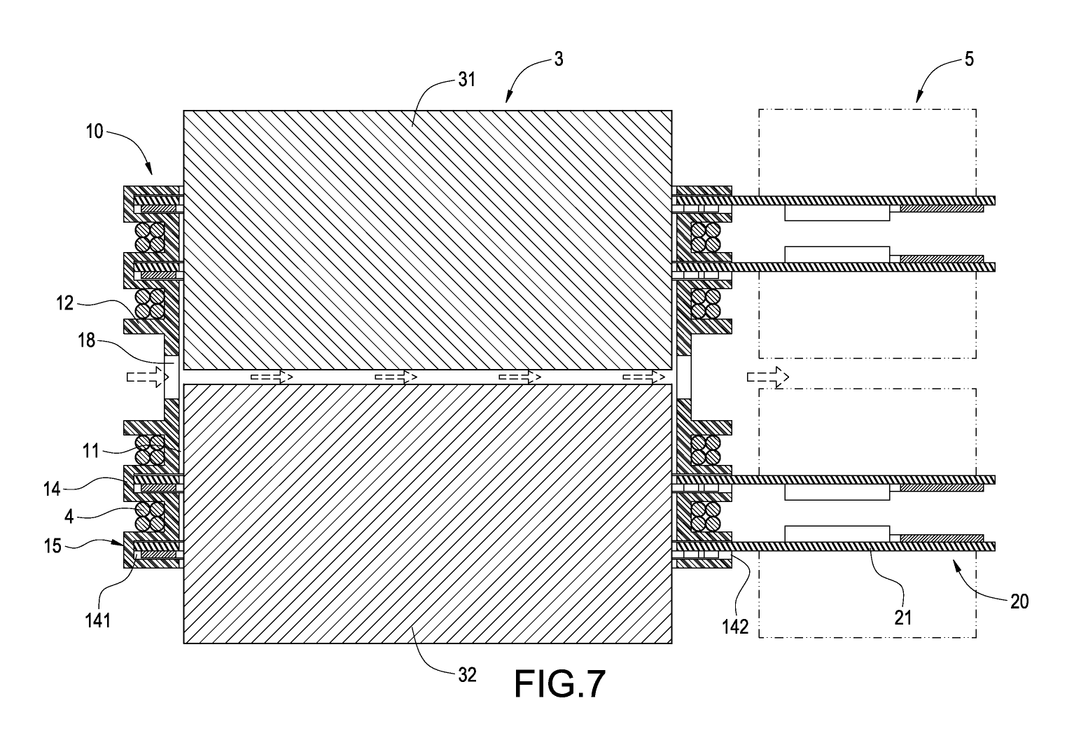

As shown in FIG. 7, in this embodiment, the primary winding 4 may be wound between any two adjacent separation plates 14 or wound between the separation plate 14 and the vertical plate 12. This may achieve the same effect as previous embodiments do. During the operation, gas with low temperature from outside area goes through the air hole 18 and the spacing gap and then takes away the heat generated by heating elements on the conducting plate 20.

1. A bobbin structure of a transformer comprising a winding frame and a plurality of conducting plates, wherein the winding frame comprises a first winding section, two second winding sections formed on two sides of the first winding section, respectively, and a channel penetrating the first winding section and the second winding sections, each second winding section includes a plurality of separation plates spaced apart, a slot connecting with the channel is disposed on the separation plate, each conducting plate has a main body and a conducting ring, and the main body is a circuit board exposed out of the separation plate while the conducting ring is correspondingly plugged into the separation plate through the plugging slot.

2. The bobbin structure of the transformer according to claim 1, wherein the winding frame is a hollow rectangular body, the channel is parallel to a centerline of the hollow rectangular body, two vertical plates parallel to and spaced apart from each other are disposed and extends along a direction perpendicular to the centerline of the rectangular body, and the first winding section is formed between two vertical plates.

3. The bobbin structure of the transformer according to claim 2, wherein an outer area of each vertical plate extends and forms the separation plates, each separation plate is parallel to each vertical plate and the second winding section is formed on each separation plate.

4. The bobbin structure of the transformer according to claim 3, wherein the slot has a plugging hole formed on a lateral side of each separation plate.

5. The bobbin structure of the transformer according to claim 3, wherein the bottom of each separation plate extends and forms a plurality of pin plates, and a plurality of pins is connected to the bottom of each pin plate.

6. The bobbin structure of the transformer according to claim 2, wherein an air hole connecting with the channel is formed on the first winding section.

7. (canceled)

8. The bobbin structure of the transformer according to claim 1, wherein a wide end of the main body extends and forms a plurality of pins.

9. The bobbin structure of the transformer according to claim 8, wherein the conducting ring comprises two horizontal sections parallel to each other, a first vertical section bending and extending from one end of each horizontal section while perpendicular to the horizontal section and a third vertical section as well as a fourth vertical section bending and extending from the other end of each horizontal section while perpendicular to the horizontal section, the third vertical section and the fourth vertical section are parallel to the first vertical section.

10. The bobbin structure of the transformer according to claim 9, wherein an opening is formed between the third vertical section and the fourth vertical section.
